(19) United States
(12) Patent Application Publication
(10) Pub. No.: US 2025/0370197 A1
(43) Pub. Date: Dec. 4, 2025

(54) MULTI-CHANNEL OPTICAL ASSEMBLY INCLUDING COMPONENT FOR PRESSING AGAINST OPTICAL COMMUNICATION CHIP AND OPTICAL TRANSMISSION UNIT

(71) Applicant: Global Technology Inc., Ningbo (CN)

(72) Inventors: Jian-hong LUO, Ningbo (CN); Dong-Biao JIANG, Ningbo (CN); Xiang ZHENG, Ningbo (CN); Rongxiang XU, Ningbo (CN)

(21) Appl. No.: 18/793,562

(22) Filed: Aug. 2, 2024

(30) Foreign Application Priority Data
May 31, 2024 (CN) 202410694376.0

(51) Int. Cl. G02B 6/42

(52) U.S. Cl. CPC G02B 6/4239; G02B 6/4245

(57) ABSTRACT

A multi-channel optical assembly includes an optical communication chip, an optical transmission unit and a pressing component. The optical transmission unit includes an optical coupling end portion optically coupled to the optical communication chip. The pressing component presses against the optical communication chip and the optical coupling end portion of the optical transmission unit. The pressing component has an extension portion. The extension portion protrudes from an edge of the optical coupling end portion. The extension portion presses against the optical communication chip.

### CROSS-REFERENCE TO RELATED APPLICATIONS

This non-provisional application claims priority under 35 U.S.C. § 119(a) on Patent Application No(s). 202410694376.0 filed in China, on May 31, 2024, the entire contents of which are hereby incorporated by reference.

### TECHNICAL FIELD

The present disclosure relates to a multi-channel optical assembly, more particularly to a multi-channel optical assembly having a pressing component.

### BACKGROUND

Optical modules may be used to transmit and/or receive optical signals for various applications including, without limitation, internet data center, cable TV and fiber to the home (FTTH). Optical modules provide higher speeds and wider bandwidth over longer distances. In order to promote the compatibility of products in global optical internet and reduce the maintenance burden, organizations such as Multi-Source Agreement (MSA), Institute of Electrical and Electronics Engineers (IEEE) and Optical Internetworking Forum (OIF) have defined various form factors applicable to different signal transmission rates. These form factors include, without limitation, XFP, SFP, QSFP (Quad Small Form Factor Pluggable), QSFP-DD (Double Density), OSFP (Octal Small Form Factor Pluggable) and CPO (Co-Packaged Optics).

Current optical modules have presented challenges regarding, for example, optical power, space management, thermal management, insertion loss, and manufacturing yield.

### SUMMARY

One embodiment of the present disclosure provides a multi-channel optical assembly including an optical communication chip, an optical transmission unit and a pressing component. The optical transmission unit includes an optical coupling end portion optically coupled to the optical communication chip. The pressing component presses against the optical communication chip and the optical coupling end portion of the optical transmission unit. The pressing component has an extension portion. The extension portion protrudes from an edge of the optical coupling end portion. The extension portion presses against the optical communication chip.

Another embodiment of the present disclosure provides a multi-channel optical assembly including a substrate, an optical communication chip, an optical transmission unit, a pressing component and a plurality of coupling adhesives. The optical communication chip is coupled to the substrate. The optical transmission unit includes an optical coupling end portion optically coupled to the optical communication chip. The pressing component presses against the optical communication chip and the optical coupling end portion of the optical transmission unit. The optical coupling end portion is adhered to the substrate and the optical communication chip via the plurality of coupling adhesives. A width of each of the plurality of coupling adhesives for adhering the optical coupling end portion to the substrate is less than a height of the optical communication chip.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a perspective view of a multi-channel optical assembly in accordance with a first embodiment of the present disclosure;

FIG. 2 is a side view of the multi-channel optical assembly in FIG. 1;

FIG. 3 is an enlarged side view of a coupling area A of the multi-channel optical assembly in FIG. 1;

FIG. 4 is a side view of a multi-channel optical assembly in accordance with a second embodiment of the present disclosure;

FIG. 5 is an enlarged side view of a coupling area B of the multi-channel optical assembly in FIG. 4;

FIG. 6 is a perspective view of a multi-channel optical assembly in accordance with a third embodiment of the present disclosure;

FIG. 7 is a side view of the multi-channel optical assembly in FIG. 6; and

FIG. 8 is an enlarged side view of a coupling area C of the multi-channel optical assembly in FIG. 6.

### DETAILED DESCRIPTION

Recently, with the development of the optical fiber communication field, integrated photonic chip technology has been developed rapidly due to advantages of the ease of integration, low cost and high transmission quality thereof. The packaging of integrated photonic chips is deemed to be one of the important aspects in this field. In an optical assembly known by inventors, an photonic chip is usually necessary to be coupled to an optical fiber array or an arrayed waveguide grating via a coupling adhesive disposed therebetween. In addition, a structural adhesive is necessary to be disposed at two sides of the photonic chip and the optical fiber array or the arrayed waveguide grating coupled to each other, so as to maintain the alignment therebetween. However, the aforementioned coupling structure requires the adhesives with high bonding strength. The misalignment of the optical assembly due to the insufficient bonding strength may cause the loss of the optical transmission signals.

An embodiment of the present disclosure provides a multi-channel optical assembly so as to prevent the loss of the optical transmission signals by improving alignment of components in the optical assembly. According to one embodiment of the present disclosure, a pressing component may cover and press against an optical communication chip and an optical coupling end portion of an optical transmission unit. Therefore, the alignment between the optical communication chip and the optical fiber array can be maintained, and the loss of the optical transmission signals can be prevented. In addition, the pressing component is helpful to distribute some amount of stress generated at coupling surfaces of the optical communication chip and the optical transmission unit to coupling surfaces of the optical communication chip, the optical transmission unit and the pressing component. Accordingly, the adverse effect generated by the stress on the alignment between the optical communication chip and the optical fiber array can be reduced.

Some technical features or all technical features disclosed in one or more embodiments of the present disclosure may be combined to achieve the correspond effects.

The term “coupled” refers to any connection or similar concept, and the term “optically coupled” refers to a concept which means that a light is transmitted/imparted from one component to another component. Unless stared otherwise, the components which are “coupled” to each other are not necessary to be connected to each other directly, and may be spaced apart from each other via other component(s).

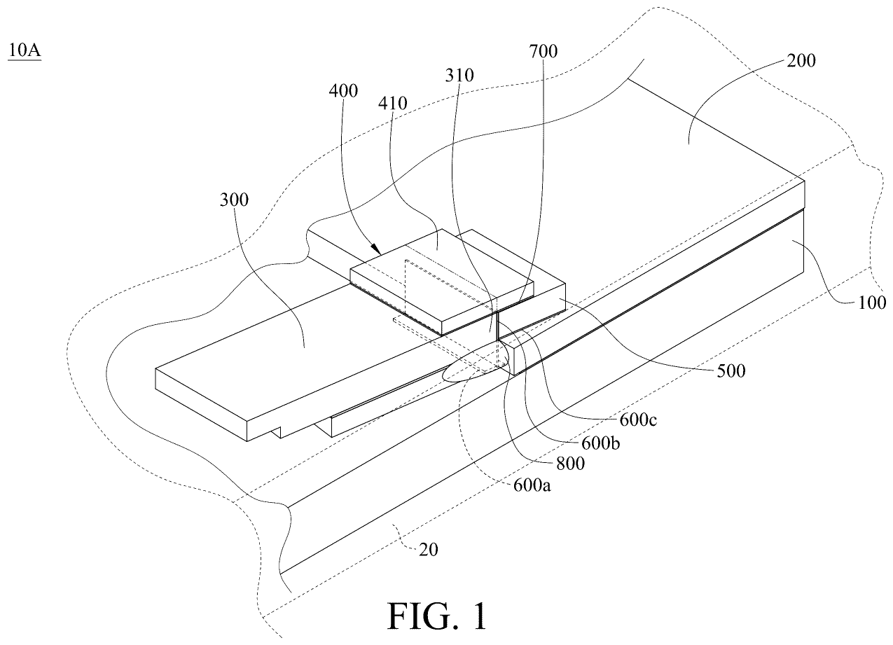

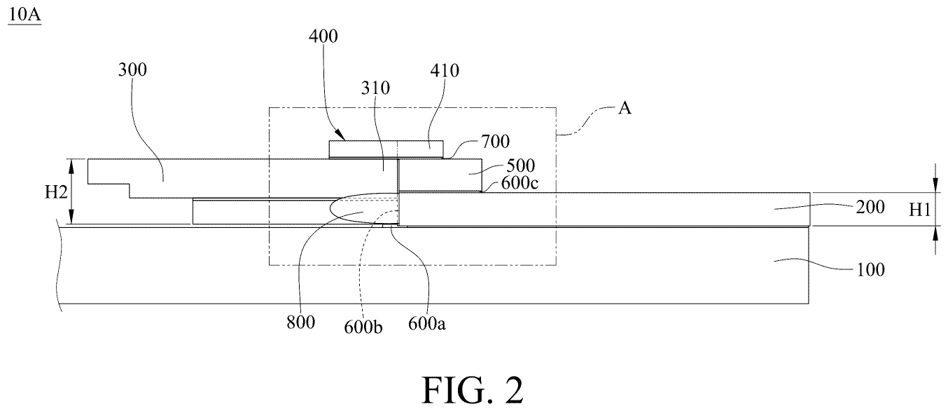

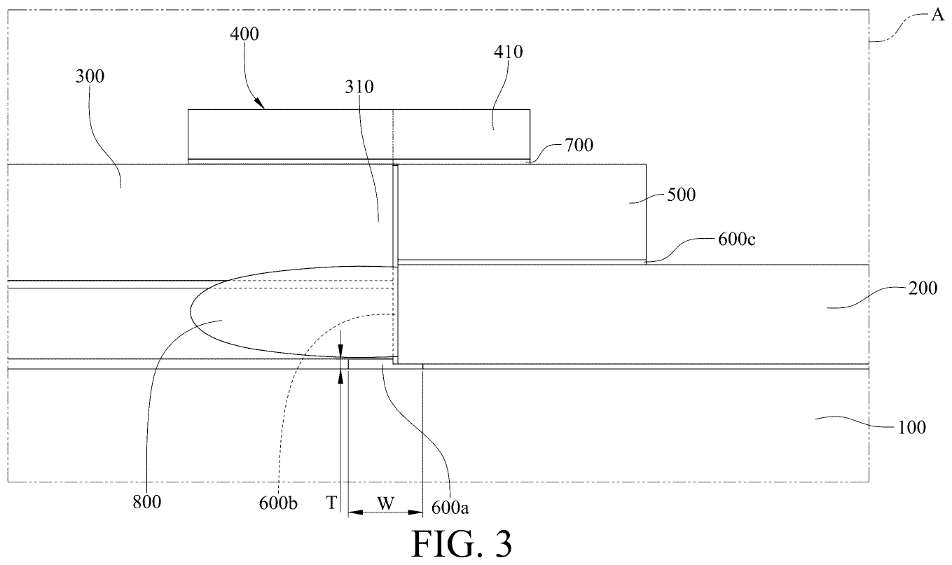

Please refer to FIG. 1 to FIG. 3, where FIG. 1 is a perspective view of a multi-channel optical assembly 10A in accordance with a first embodiment of the present disclosure, FIG. 2 is a side view of the multi-channel optical assembly 10A in FIG. 1, and FIG. 3 is an enlarged side view of a coupling area A of the multi-channel optical assembly 10A in FIG. 1.

In this embodiment, the multi-channel optical assembly 10A may include a substrate 100, an optical communication chip 200, an optical transmission unit 300 and a pressing component 400. The optical communication chip 200 may be coupled to the substrate 100. The optical transmission unit 300 may include an optical coupling end portion 310. The optical coupling end portion 310 may be stacked on and coupled to the substrate 100 and the optical communication chip 200.

In this embodiment, a thickness of the pressing component 400 may be less than a height of the optical transmission unit 300. The pressing component 400 may cover and press against the optical communication chip 200 and the optical coupling end portion 310 of the optical transmission unit 300. In one embodiment, the pressing component 400 may press against the optical coupling end portion 310 by the weight itself or by an external force applied onto the pressing component 400. The pressing component 400 has an extension portion 410. The extension portion 410 may protrude from an edge of the optical coupling end portion 310, and may press against the optical communication chip 200.

The substrate 100 may be considered as a printed circuit board assembly (PCBA), a light emitting assembly, a light receiving assembly or both of the two assemblies may be coupled to the PCBA. The light emitting assembly may be considered as a transmitting optical sub-assembly (TOSA), and the light receiving assembly may be considered as a receiver optical sub-assembly (ROSA). In one embodiment, the substrate 100 may be considered as a baseplate coupled to a PCBA or a TOSA housing. In one embodiment, the substrate 100 may be considered as a bottom of a TOSA housing. In one embodiment, the substrate 100 may be considered as a bottom of a transceiver housing.

In one embodiment, the optical communication chip 200 may be considered as a silicon photonic chip or an integrated circuit including Mach-Zehnder modulator such as thin film lithium niobate modulator. In one embodiment, the optical communication chip 200 may include the light emitting assembly and the light receiving assembly aforementioned. In one embodiment, the optical communication chip 200 may include a laser diode and an optical modulator, or may include a photodiode or a transimpedance amplifier (TIA). In one embodiment, the optical communication chip 200 may be considered as an active optical device including a photonic integrated circuit (PIC), an electronic integrated circuit (EIC) or both.

In one embodiment, the optical transmission unit 300 may be considered as an optical fiber array, an arrayed waveguide grating or both; or, the optical transmission unit 300 may be considered as a passive optical device including one of the optical fiber array and the arrayed waveguide grating. In one embodiment, the optical coupling end portion 310 may be considered as an optical input or an optical output of the optical transmission unit 300, and is optically coupled to the light emitting assembly or the light receiving assembly of the optical communication chip 200. FIG. 3 exemplarily depicts that the optical transmission unit 300 is an optical fiber array including an upper cap and a lower base, with V grooves for receiving fibers formed on either the upper cap or the lower base.

In this embodiment, the multi-channel optical assembly 10A may further include a housing 20. The optical communication chip 200, the optical transmission unit 300 and the pressing component 400 may be accommodated in the housing 20. In an embodiment where the multi-channel optical assembly 10A is considered as an optical transceiver, the housing 20 may be configured to accommodate the PCBA, the transmitting optical sub-assembly and the receiver optical sub-assembly. In an embodiment where the multi-channel optical assembly 10A is considered as the transmitting optical sub-assembly or the receiver optical sub-assembly, the housing 20 may be hermetically packaged or non-hermetically packaged configured to accommodate the optical communication chip 200, and an electrical feedthrough device may be partially located in the housing 20 additionally.

In this embodiment, the multi-channel optical assembly 10A may further include an intermediate component 500. A height H1 of the optical communication chip 200 may be, for example, less than a height H2 of the optical coupling end portion 310. For example, the height H1 of the optical communication chip 200 may be 0.4 millimeters, and the height H2 of the optical coupling end portion 310 may be 0.9 millimeters. The optical communication chip 200 is spaced apart from the pressing component 400. When the intermediate component 500 is provided between the optical communication chip 200 and the pressing component 400, the pressing component 400 may press against the optical communication chip 200 via the intermediate component 500. Accordingly, the alignment between the optical communication chip 200 and the optical transmission unit 300 can be maintained, and the loss of the optical transmission signals can be prevented.

In this embodiment, the pressing component 400 and the intermediate component 500 may be two separate components, but the present disclosure is not limited thereto. In other embodiments, the pressing component and the intermediate component may be integrally formed as a single piece.

In this embodiment, the multi-channel optical assembly 10A may further include a plurality of coupling adhesives 600a, 600b and 600c. The optical coupling end portion 310 is adhered to the substrate 100 via the coupling adhesive 600a, and is adhered to the optical communication chip 200 and the intermediate component 500 via the coupling adhesives 600b. The intermediate component 500 is adhered to the optical communication chip 200 via the coupling adhesives 600c.

In this embodiment, the multi-channel optical assembly 10A may further include a bonding adhesive 700. The pressing component 400 is adhered to the optical coupling end portion 310 and the intermediate component 500 via the bonding adhesive 700. In one embodiment, the coupling adhesive 600a may be replaced with the bonding adhesive 700, and the bonding adhesive 700 is configured to adhere the substrate 100 and the optical communication chip 200.

In this embodiment, the multi-channel optical assembly 10A may further include a structural adhesive 800. The optical coupling end portion 310 is adhered to the optical communication chip 200 via the structural adhesive 800.

In this embodiment, coefficients of thermal expansion of the substrate 100, the optical communication chip 200, the pressing component 400, the coupling adhesives 600a, 600b and 600c, the bonding adhesive 700 and the structural adhesive 800 are matched with each other. That is, the coefficients of thermal expansion of the substrate 100, the optical communication chip 200, the pressing component 400, the coupling adhesives 600a, 600b and 600c, the bonding adhesive 700 and the structural adhesive 800 are, for example, equal to each other. Accordingly, the coupling surface can be prevented from breaking due to the thermal stress caused by difference in thermal expansion coefficients.

In this embodiment, the structural adhesive 800 may be configured as a structural reinforcement for coupling the optical communication chip 200 and the optical transmission unit 300 so as to enhance the coupling strength between the optical communication chip 200 and the optical transmission unit 300. Accordingly, the alignment between the optical communication chip 200 and the optical transmission unit 300 can be maintained.

In this embodiment, a thickness T of the coupling adhesive 600a between the optical transmission unit 300 and the substrate 100 may be less than the height H1 of the optical communication chip 200. Accordingly, the stress generated by the coupling adhesive 600a due to the thermal expansion can be reduced effectively, and the coupling adhesive 600a can withstand a certain level of impact. The thickness T of the coupling adhesive 600a may, for example, range from 0.03 millimeters to 0.1 millimeters.

In this embodiment, a width W of the coupling adhesive 600a between the optical transmission unit 300 and the substrate 100 may be less than the height H1 of the optical communication chip 200. Accordingly, the stress generated by the coupling adhesive 600a due to the thermal expansion can be reduced effectively, and the coupling adhesive 600a can withstand a certain level of impact. The width W of the coupling adhesive 600a may, for example, range from 0.1 millimeters to 0.3 millimeters.

In this embodiment, the coupling adhesives 600a, 600b and 600c may be, for example, epoxy resins which have a specification of AC A535-AN, the bonding adhesive 700 may be, for example, epoxy resin which has a specification of OPTOCAST 3410, and the structural adhesive 800 may be, for example, epoxy resin which has a specification of EB-350-4LV, but the present disclosure is not limited thereto.

In this embodiment, a light within the multi-channel optical assembly 10A may be transmitted from the optical coupling end portion 310 to the optical communication chip 200, or may be transmitted from the optical communication chip 200 to the optical coupling end portion 310.

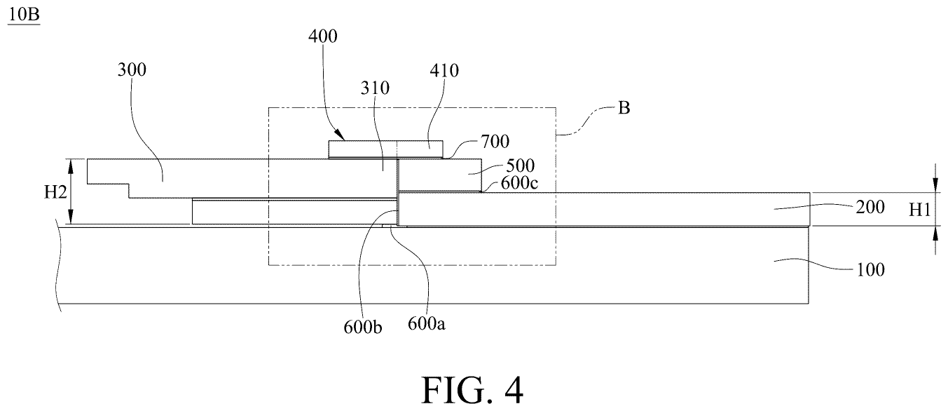

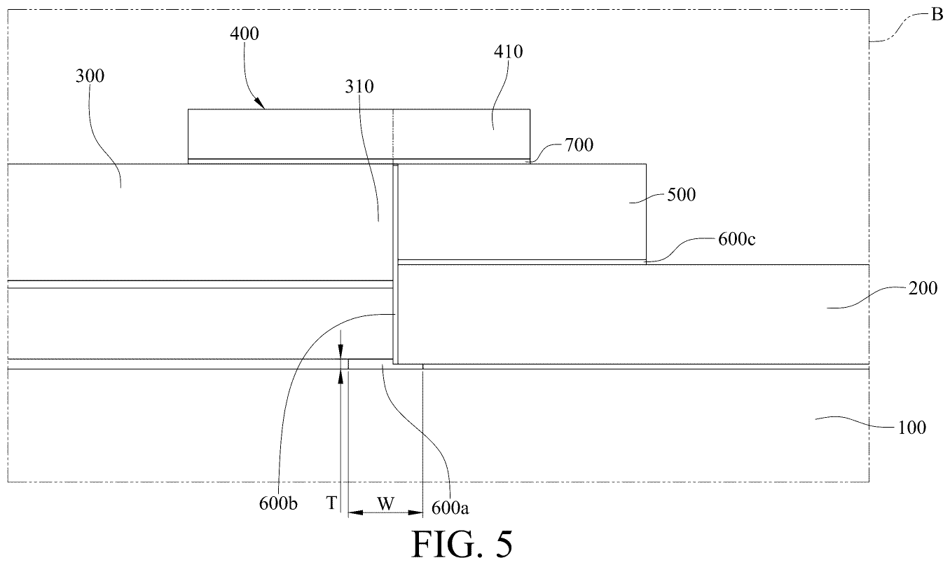

In the first embodiment, the multi-channel optical assembly 10A includes the structural adhesive 800, but the present disclosure is not limited thereto. Please refer to FIG. 4 and FIG. 5, where FIG. 4 is a side view of a multi-channel optical assembly 10B in accordance with a second embodiment of the present disclosure, and FIG. 5 is an enlarged side view of a coupling area B of the multi-channel optical assembly 10B in FIG. 4. In this embodiment, the multi-channel optical assembly 10B may not include the structural adhesive 800 in FIG. 1 to FIG. 3.

In this embodiment, the multi-channel optical assembly 10B may include a plurality of coupling adhesives 600a, 600b and 600c and a bonding adhesive 700. The optical coupling end portion 310 is adhered to the substrate 100 via the coupling adhesive 600a, and is adhered to the optical communication chip 200 and the intermediate component 500 via the coupling adhesives 600b. The intermediate component 500 is adhered to the optical communication chip 200 via the coupling adhesives 600c. The pressing component 400 is adhered to the optical coupling end portion 310 and the intermediate component 500 via the bonding adhesive 700.

In this embodiment, coefficients of thermal expansion of the substrate 100, the optical communication chip 200, the pressing component 400, the coupling adhesives 600a, 600b and 600c and the bonding adhesive 700 are matched with each other. That is, the coefficients of thermal expansion of the substrate 100, the optical communication chip 200, the pressing component 400, the coupling adhesives 600a, 600b and 600c and the bonding adhesive 700 are, for example, equal to each other. Accordingly, the coupling surface can be prevented from breaking due to the thermal stress.

In this embodiment, a thickness T of the coupling adhesive 600a between the optical transmission unit 300 and the substrate 100 may be less than a height H1 of the optical communication chip 200. Accordingly, the stress generated by the coupling adhesive 600a due to the thermal expansion can be reduced effectively, and the coupling adhesive 600a can withstand a certain level of impact. The thickness T of the coupling adhesive 600a may, for example, range from 0.03 millimeters to 0.1 millimeters.

In this embodiment, a width W of the coupling adhesive 600a between the optical transmission unit 300 and the substrate 100 may be less than the height H1 of the optical communication chip 200. Accordingly, the stress generated by the coupling adhesive 600a due to the thermal expansion can be reduced effectively, and the coupling adhesive 600a can withstand a certain level of impact. The width W of the coupling adhesive 600a may, for example, range from 0.1 millimeters to 0.3 millimeters.

In this embodiment, the coupling adhesives 600a, 600b and 600c may be, for example, epoxy resins which have a specification of AC A535-AN, and the bonding adhesive 700 may be, for example, epoxy resin which has a specification of OPTOCAST 3410, but the present disclosure is not limited thereto.

In this embodiment, a light within the multi-channel optical assembly 10B may be transmitted from the optical coupling end portion 310 to the optical communication chip 200, or may be transmitted from the optical communication chip 200 to the optical coupling end portion 310.

In the first and second embodiments, the height (H1) of the optical communication chip of the multi-channel optical assembly including the pressing component is less than the height (H2) of the optical coupling end portion. Therefore, the intermediate component is necessary to be provided between the optical communication chip and the pressing component in each of the multi-channel optical assemblies 10A and 10B, so that the pressing component may press against the optical communication chip 200 via the intermediate component, but the present disclosure is not limited thereto.

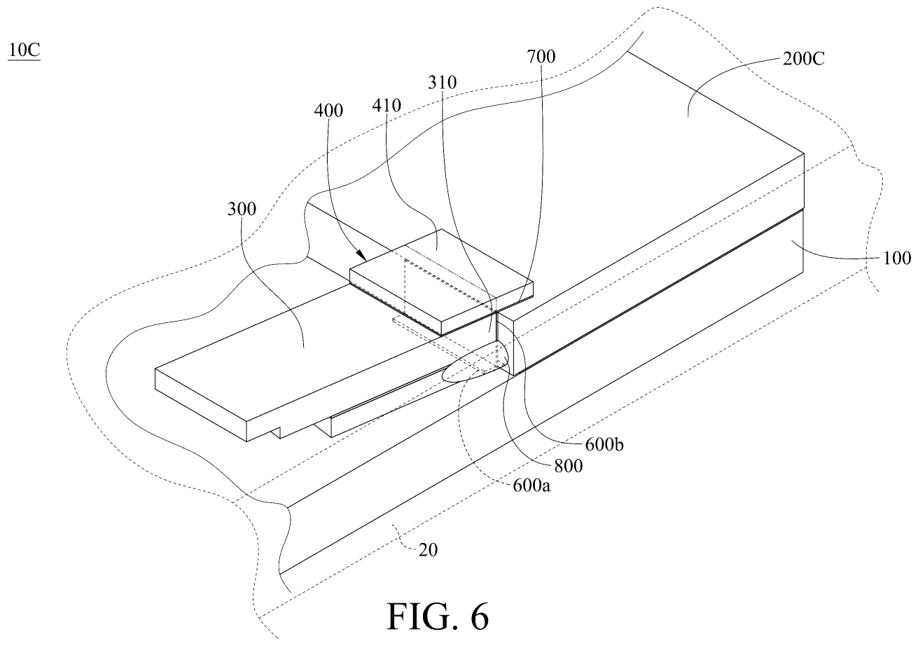

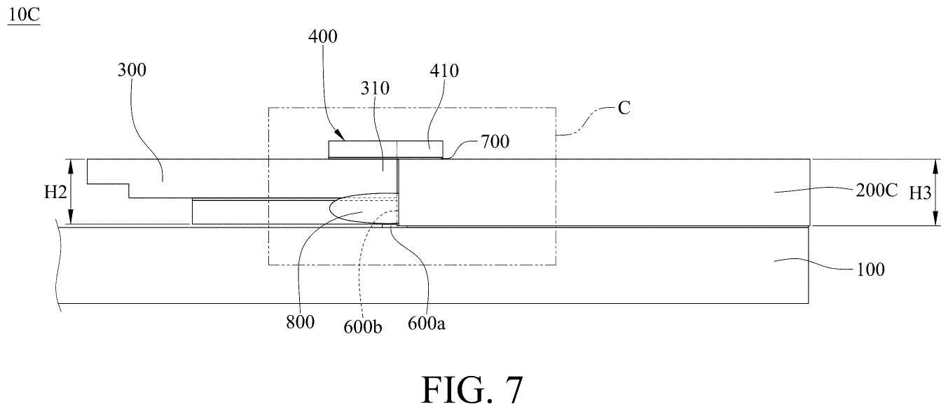

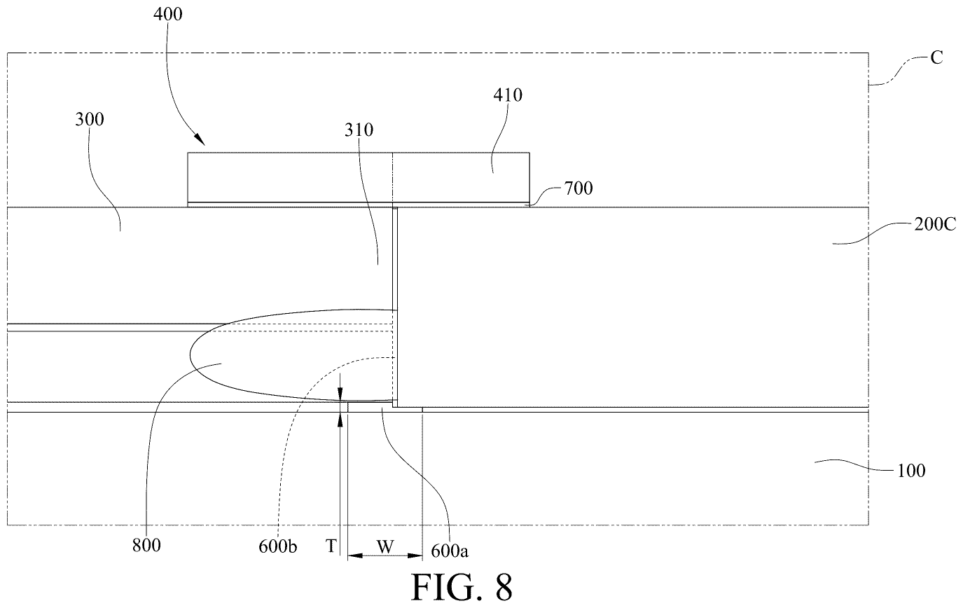

Please refer to FIG. 6 to FIG. 8, where FIG. 6 is a perspective view of a multi-channel optical assembly 10C in accordance with a third embodiment of the present disclosure, FIG. 7 is a side view of the multi-channel optical assembly 10C in FIG. 6, and FIG. 8 is an enlarged side view of a coupling area C of the multi-channel optical assembly 10C in FIG. 6.

In this embodiment, a height H3 of the optical communication chip 200C may be equal to a height H2 of the optical coupling end portion 310, so the pressing component 400 may press against the optical communication chip 200C directly. Accordingly, the alignment between the optical communication chip 200C and the optical transmission unit 300 can be maintained, and the loss of the optical transmission signals can be prevented.

In this embodiment, the multi-channel optical assembly 10C may include a plurality of coupling adhesives 600a, 600b and a bonding adhesive 700. The optical coupling end portion 310 is adhered to the substrate 100 via the coupling adhesive 600a, and is adhered to the optical communication chip 200C via the coupling adhesives 600b. The pressing component 400 is adhered to the optical communication chip 200C and the optical coupling end portion 310 via the bonding adhesive 700.

In this embodiment, the multi-channel optical assembly 10C may further include a structural adhesive 800. The optical coupling end portion 310 is adhered to the optical communication chip 200C via the structural adhesive 800.

In this embodiment, coefficients of thermal expansion of the substrate 100, the optical communication chip 200C and the pressing component 400 are matched with each other. That is, coefficients of thermal expansion of the substrate 100, the optical communication chip 200C and the pressing component 400 are, for example, equal to each other. Accordingly, the coupling surface can be prevented from breaking due to the thermal stress.

In this embodiment, the structural adhesive 800 may be configured as a structural reinforcement for coupling the optical transmission unit 300 and the optical communication chip 200C so as to enhance the coupling strength between the optical transmission unit 300 and the optical communication chip 200C. Accordingly, the alignment between the optical transmission unit 300 and the optical communication chip 200C can be maintained.

In this embodiment, a thickness T of the coupling adhesive 600a between the optical transmission unit 300 and the substrate 100 may be less than the height H3 of the optical communication chip 200C. Accordingly, the stress generated by the coupling adhesive 600a due to the thermal expansion can be reduced effectively, and the coupling adhesive 600a can withstand a certain level of impact. The thickness T of the coupling adhesive 600a may, for example, range from 0.03 millimeters to 0.1 millimeters.

In this embodiment, a width W of the coupling adhesive 600a between the optical transmission unit 300 and the substrate 100 may be less than the height H3 of the optical communication chip 200C. Accordingly, the stress generated by the coupling adhesive 600a due to the thermal expansion can be reduced effectively, and the coupling adhesive 600a can withstand a certain level of impact. The width W of the coupling adhesive 600a may, for example, range from 0.1 millimeters to 0.3 millimeters.

In this embodiment, the coupling adhesives 600a and 600b may be, for example, epoxy resins which have a specification of AC A535-AN, the bonding adhesive 700 may be, for example, epoxy resin which has a specification of OPTOCAST 3410, and the structural adhesive 800 may be, for example, epoxy resin which has a specification of EB-350-4LV, but the present disclosure is not limited thereto.

In this embodiment, a light within the multi-channel optical assembly 10C may be transmitted from the optical coupling end portion 310 to the optical communication chip 200C, or may be transmitted from the optical communication chip 200C to the optical coupling end portion 310.

It will be apparent to those skilled in the art that various modifications and variations can be made to the present disclosure. It is intended that the specification and examples be considered as exemplary embodiments only, with a scope of the present disclosure being indicated by the following claims.

What is claimed is:

1. A multi-channel optical assembly, comprising:
an optical communication chip;
an optical transmission unit, comprising an optical coupling end portion optically coupled to the optical communication chip; and
a pressing component, pressing against the optical communication chip and the optical coupling end portion of the optical transmission unit;
wherein the pressing component has an extension portion, the extension portion protrudes from an edge of the optical coupling end portion, and the extension portion presses against the optical communication chip.

2. The multi-channel optical assembly according to claim 1, further comprising an intermediate component located between the pressing component and the optical communication chip, wherein the pressing component presses against the optical communication chip via the intermediate component.

3. The multi-channel optical assembly according to claim 2, further comprising a plurality of coupling adhesives, wherein the optical coupling end portion is adhered to the optical communication chip and the intermediate component via a part of the plurality of coupling adhesives, and the intermediate component is adhered to the optical communication chip via another part of the plurality of coupling adhesives.

4. The multi-channel optical assembly according to claim 2, further comprising a bonding adhesive, wherein the pressing component is adhered to the optical coupling end portion and the intermediate component via the bonding adhesive.

5. The multi-channel optical assembly according to claim 1, wherein a thickness of the pressing component is less than a height of the optical transmission unit.

6. The multi-channel optical assembly according to claim 1, further comprising a housing, wherein the optical communication chip, the optical transmission unit and the pressing component are accommodated in the housing.

7. The multi-channel optical assembly according to claim 2, further comprising a substrate, wherein the optical communication chip is coupled to the substrate, and the optical transmission unit is coupled to the substrate or the optical communication chip.

8. The multi-channel optical assembly according to claim 7, further comprising a plurality of coupling adhesives, a bonding adhesive and a structural adhesive, wherein the optical coupling end portion is adhered to the substrate, the optical communication chip and the intermediate component via a part of the plurality of coupling adhesives, the intermediate component is adhered to the optical communication chip via another part of the plurality of coupling adhesives, the pressing component is adhered to the optical coupling end portion and the intermediate component via the bonding adhesive, the optical coupling end portion is adhered to the optical communication chip via the structural adhesive, and coefficients of thermal expansion of the substrate, the pressing component, the optical communication chip, the plurality of coupling adhesives, the bonding adhesive and the structural adhesive are matched with each other.

9. The multi-channel optical assembly according to claim 1, further comprising a coupling adhesive and a bonding adhesive, wherein the optical coupling end portion is adhered to the optical communication chip via the coupling adhesive, and the pressing component is adhered to the optical communication chip and the optical coupling end portion via the bonding adhesive.

10. A multi-channel optical assembly, comprising:
a substrate;
an optical communication chip, coupled to the substrate;
an optical transmission unit, comprising an optical coupling end portion optically coupled to the optical communication chip;
a pressing component, pressing against the optical communication chip and the optical coupling end portion of the optical transmission unit; and
a plurality of coupling adhesives, wherein the optical coupling end portion is adhered to the substrate and the optical communication chip via the plurality of coupling adhesives, and a width of each of the plurality of coupling adhesives for adhering the optical coupling end portion to the substrate is less than a height of the optical communication chip.

11. The multi-channel optical assembly according to claim 10, wherein the pressing component has an extension portion, the extension portion protrudes from an edge of the optical coupling end portion, and the extension portion presses against the optical communication chip.

12. The multi-channel optical assembly according to claim 10, wherein a thickness of the pressing component is less than a height of the optical transmission unit.

13. The multi-channel optical assembly according to claim 10, further comprising a housing, wherein the substrate, the optical communication chip, the optical transmission unit and the pressing component are accommodated in the housing.

14. The multi-channel optical assembly according to claim 10, further comprising an intermediate component located between the pressing component and the optical communication chip, wherein the pressing component presses against the optical communication chip via the intermediate component.

15. The multi-channel optical assembly according to claim 14, wherein the optical coupling end portion is adhered to the substrate, the optical communication chip and the intermediate component via a part of the plurality of coupling adhesives, and the intermediate component is adhered to the optical communication chip via another part of the plurality of coupling adhesives.

16. The multi-channel optical assembly according to claim 14, further comprising a bonding adhesive, wherein the pressing component is adhered to the optical coupling end portion and the intermediate component via the bonding adhesive.

17. The multi-channel optical assembly according to claim 14, further comprising a bonding adhesive and a structural adhesive, wherein the optical coupling end portion is adhered to the substrate, the optical communication chip and the intermediate component via a part of the plurality of coupling adhesives, the intermediate component is adhered to the optical communication chip via another part of the plurality of coupling adhesives, the pressing component is adhered to the optical coupling end portion and the intermediate component via the bonding adhesive, the optical coupling end portion is adhered to the optical communication chip via the structural adhesive, and coefficients of thermal expansion of the substrate, the pressing component, the optical communication chip, the plurality of coupling adhesives, the bonding adhesive and the structural adhesive are matched with each other.

18. The multi-channel optical assembly according to claim 10, further comprising a bonding adhesive, wherein the pressing component is adhered to the optical communication chip and the optical coupling end portion via the bonding adhesive.
